(19) United States
(12) Patent Application Publication
(10) Pub. No.: US 2022/0216025 A1
(43) Pub. Date: Jul. 7, 2022

(54) MELTING CONDUCTOR AND FUSE

(71) Applicant: SIBA Fuses GmbH, Lünen (DE)

(72) Inventors: Jens WEBER, Dortmund (DE); Johannes-Georg GÖDEKE, Lünen (DE); Thorsten GLINTZER, Welver (DE); Markus LIPPOLD, Hamm (DE)

(21) Appl. No.: 17/611,221

(22) PCT Filed: Mar. 12, 2020
(86) PCT No.: PCT/EP2020/056644

§ 371 Date: Nov. 15, 2021

(30) Foreign Application Priority Data
May 16, 2019 (DE) 10 2019 003 448.1
Jun. 18, 2019 (DE) 10 2019 004 223.9

(51) Int. Cl. H01H 85/041; H01H 85/11

(52) U.S. Cl. CPC H01H 85/0415; H01H 85/11

(57) ABSTRACT

The invention relates to a melting conductor (1) provided for use for a fuse (2), preferably for a miniature fuse, with an electrically conductive melting wire (3). According to the invention an electrically insulating and/or electrically non-conductive covering (5) surrounding the outer shell surface (4) of the melting wire (3) at least in certain areas, preferably completely, is provided.

The present invention relates to a melting conductor intended for use for a fuse, preferably a miniature fuse, having an electrically conductive melting wire.

Furthermore, the present invention relates to a fuse, in particular a miniature fuse, having an outer fuse box. In the fuse box, at least one melting conductor of the aforementioned type is arranged wound around a winding body, in particular an electrically insulating winding body.

Melting conductors for fuses are known in the prior art. As mentioned above, melting conductors are wound around a winding body, wherein the winding body is electrically non-conductive. The winding ultimately serves to increase the effective length of the melting conductor without increasing the length of the entire fuse. By lengthening the melting conductor, a more slow and/or inert characteristic and a higher rated voltage can be achieved. The more densely the wire is wound—that is, the more turns are wound per unit length—the higher is in particular the electrical resistance of the melting conductor per unit length. The heat load per unit length also increases.

A denser and/or tighter winding of the melting conductor is necessary if low rated currents with slow characteristics are to be protected by the fuse.

In practice, however, the problem arises that the winding spacing cannot be reduced at will. Ultimately, in order to avoid electrical short circuits, it is necessary to limit the winding spacing to at least 0.5 to 1.5 times the diameter of the melting conductor. Otherwise, it would not be possible to reliably prevent an electrical short-circuit between proximity windings, since a spark-over can be caused between the windings. So-called “near-shorts” and/or turn shorts are also possible, wherein this ultimately leads to a non-standardized fuse behavior of the voltage and/or current, as this changes the characteristics of the fuse.

In addition, the more tightly the windings are to be wound, the more complex is the producing of the melting conductor wound around the winding body. Local variations in winding density and/or winding distances cannot be avoided, which has a detrimental effect on the fuse and load behavior as well as the characteristics of the fuse's disconnection behavior.

Since fuses are used in a technically very sensitive area and in particular for (overload) protection, any fluctuations and/or supposed short-circuits (“near-shorts”) must be avoided as far as possible. Consequently, the winding density must not fall below a specified winding distance.

It is necessary that the fuse comprises an appropriate (fuse) characteristic for the standardized and/or specified values. This is not the case if there is an electrical connection at the contact points of the windings, which is why the minimum winding distance is decisive.

However, even with larger distances, the manufacturing process cannot prevent the winding distance from being too small, at least in some areas, so that the melting conductor can short-circuit in smaller areas. This can also be caused by the properties of the melting conductor itself and/or light, in particular conductive contamination between the windings of the melting conductor can lead to a short circuit.

Another problem is the use of flux in the solder, which is required for contacting the ends of the fusible link. If wires with a tin coating and/or melting conductors comprising tin are used as melting conductors, the flux can attack the tin layer and/or tin material and form solder bridges by melting during the necessary reflow process. This has a detrimental effect on the fuse behavior, wherein the values specified for the fuse, in particular the characteristic, melting time and/or other limit values, can no longer be maintained.

The object of the present invention is now to provide a melting conductor and/or a fuse which reduces and/or at least substantially reduces the aforementioned problems and/or challenges of the prior art.

According to the invention, the aforementioned object is at least substantially solved in a melting conductor of the type mentioned above by providing an electrically insulating and/or electrically non-conductive covering which surrounds the outer surface of the melting wire at least in certain areas, preferably completely.

Preferably, the electrically insulating covering is arranged directly on the outer surface of the melting wire and in particular encloses the entire outer surface of the melting wire. Ultimately, therefore, the covering envelops the melting wire so that the melting wire acts as the core of the melting conductor.

An electrically insulating and/or electrically non-conductive covering is a covering that is not electrically conductive and/or does not affect the electrical conductivity of the melting wire. In particular, no current is conducted via the covering.

Due to the covering surrounding the melting wire, the distance between the windings in particular can be drastically reduced compared to (melting) fuses known from the prior art, in particular to almost 0 mm. Ultimately, the covering of one winding can touch the covering of the proximity winding. This enables the use of fuses that comprise a completely new dimensioning compared to fuses known from the prior art. According to the invention, it is possible to provide a melting conductor for a fuse without the risk of an electrical short circuit or other impairment.

According to the invention, the restrictions of the prior art with regard to the winding spacing are overcome in an advantageous manner.

Even if the melting conductor windings are very close to each other, a short circuit between the windings can be reliably prevented, since the electrically conductive melting wire is ultimately surrounded by an electrical insulation (covering). Thus, an electrical short circuit between proximity windings of the melting conductor is prevented.

This also solves the problem of locally varying winding spacing due to the manufacturing process and/or due to tolerances of the winding machine. According to the invention, the winding distance can also vary.

Furthermore, the covering can solve another problem of the state of the art. The solders used in the fuse can now no longer influence the electrical conductivity of the melting wire, since the melting wire does not have to be directly exposed to the solder and/or the flux. This also applies in particular to that part of the melting conductor which is not to be soldered in. The fluxes and/or solders used can also be adjusted to be more chemically aggressive, but in particular more process-optimized. According to the invention, the metal alloys and/or the metal of the melting wire is protected from the flux by the covering. Accordingly, the covering also provides a chemical protective layer for the melting wire.

Particularly advantageous is the use of the melting conductor for a miniature fuse—that is, for a safety fuse. Miniature fuses are standardized in the DIN 60127 series, in particular DIN EN IEC 60127 (as of May 2019), wherein a plurality of DIN standards correspond to the aforementioned series. The melting conductor according to the invention enables miniature fuses to be provided for very inertial behavior, in particular for low rated currents.

The miniature fuse is a melting fuse and an overcurrent protection device which interrupts the circuit by melting the melting conductor if the current exceeds a certain value for a sufficient and/or predeterminable time. The term “melting fuse” is also defined in the aforementioned DIN series. Miniature fuses can alternatively also be referred to as GS fuses (in German language). Miniature fuses are manufactured for rated currents of about 0.03 to 40 A with a breaking capacity of about 5 A to 300 kA, in particular about 10 A to 300 kA. The length and/or width of the miniature fuse is regulated depending on specific country specifications.

In a more preferably embodiment, the covering is configured as a coating. Preferably, the coating is a lacquer. The application of the covering as a coating enables in particular a simple application of the covering and/or a simple manufacturing process for the melting conductor according to the invention, in particular wherein a “conventional” melting wire can be configured as a melting conductor according to the invention by coating with the covering.

Preferably, such a coating can be used which is formed by a solution of polymers in a, in particular cresolic, solvent mixture. Alternatively or additionally, it may be provided that the coating comprises as material resin, preferably dissolved in a solvent mixture. The resin dissolved in the solvent mixture may in particular comprise additives and/or a curing catalyst. Furthermore, the coating may comprise a plastic, preferably polyurethane, as a material and/or be configured as a polyimide lacquer.

The aforementioned configuration of the covering according to the invention enables the electrically insulating and/or electrically non-conductive function of the covering. The lacquer and/or coating can, for example, be painted on and then baked at temperatures between 300 and 600° C. More preferably, smooth, concentric and pore-free films are obtained, wherein a multiple paint application and subsequent baking can also be provided. Thus, the coating can be coated and baked between 5 to 30 times, preferably between 6 to 20 times.

Polyimide lacquer is advantageous in particular because of its high thermal load-bearing capacity. This ultimately enables the covering to be subjected to high thermal stresses, in particular caused by the current passing through the melting wire, without impairing the electrical insulation of the melting wire.

Preferably, the covering is configured to be metal-free—that is, the material of the covering comprises at least substantially no metal or metal alloy. In a further embodiment, the covering may be configured as a silicone covering and/or comprise and/or consist of a plastic and/or silicone as the material. Silicones may be referred to as poly(organo)siloxanes, and in particular indicate a group of synthetic polymers in which silicon atoms are linked via oxygen atoms. The silicone covering provides cost-effective electrical insulation of the melting wire, which in particular is permanently bonded to the outer surface of the melting wire.

The covering can, in particular directly or indirectly, be firmly bonded to the, preferably entire, outer surface of the melting wire, preferably in a material-bonding manner. In particular, the bond between the outer surface of the melting wire and the covering can be produced during the producing of the covering of the melting wire itself and/or during the application of the covering. If the covering is configured as a coating and/or silicone covering and is produced by application to the outer sheath surface of the melting wire, the aforementioned bond results more preferably “automatically”.

In a further very particularly preferred embodiment, it is provided that the material of the covering comprises a proportion and/or a proportion by weight, in particular a proportion by mass, of the total material of the melting conductor of between 0.1 and 25 wt. %, preferably between 1 and 20 wt. %, further preferably between 5 and 15 wt. % and in particular at least substantially between 8 and 12 wt. %. The aforementioned mass proportion of the material of the covering to the total material of the melting conductor indicates that the covering ultimately comprises a rather small proportion of the material of the melting conductor. Particularly preferably, the melting conductor consists primarily of the melting wire, wherein the melting wire comprises a mass fraction of the total material of the melting conductor between 30 to 99.9 wt. %, preferably between 60 to 95 wt. %. Particularly preferably, the covering is in the form of a lacquer film which has been applied around the outer surface of the melting wire.

In addition, in a further preferred embodiment of the invention, the melting wire can comprise a further covering which at least partially surrounds the melting wire. The further covering can be arranged between the melting wire and the covering. In particular, the further covering is provided directly on the outer surface of the melting wire and surrounds, preferably completely, the outer surface of the melting wire. The further covering can be surrounded by the electrically non-conductive and/or electrically insulating covering at least in some areas, preferably completely, on its outer surface facing away from the melting wire. Particularly preferably, the further covering is also configured to be electrically conductive.

The further covering can comprise as material metal, in particular a metal alloy, preferably tin and/or a tin alloy. The further covering can further preferably serve to weaken the physico-chemical processes in the event of an overload, thus in particular enabling a shutdown—also known as the M-effect.

In the case of overload currents, the greatest heat development ultimately occurs at the narrow point of the melting wire and/or melting conductor in the area of application of the further covering, in particular in the area of the tin application, which heats up the material of the further covering, in particular the tin or tin alloy. When the melting temperature is exceeded, the tin becomes liquid and forms an alloy with the material of the melting wire. Compared to the material of the melting wire, this alloy has a lower electrical and thermal conductivity and, in particular, a lower melting point. As a result of the further increase in heat generation, the melting conductor and/or melting wire becomes molten at the corresponding point below the actual melting point and separates the current path. This phenomenon was discovered by Metcalf in 1939, which is why it is also known and referred to as the M-effect. A fuse, in particular a miniature fuse, can thus exploit the previously described M-effect to trigger the fuse by applying the further covering, which in particular comprises and/or consists of tin, to the outside of the melting wire.

Particularly preferably, the covering also becomes molten when the melting point of the melting wire and/or the further covering is exceeded.

Preferably, the melting wire, the covering and/or the further covering is configured to comprise an at least substantially circular outer cross-section. Particularly preferably, the melting wire comprises a circular cross-section and is configured in particular to be cylindrical. The covering and/or the further covering can, preferably directly or indirectly, be arranged adjacent to the outer circumferential surface of the melting wire and preferably comprise an annular cross section and/or be configured as a hollow cylinder. The aforementioned configuration of the melting wire and the covering enables simple producing and simple coating of the melting wire with the covering.

In addition, such a melting wire can be wound around a winding body particularly well, in particular in different directions.

In particular, the shapes and/or the form of the further covering and/or the covering can be configured to correspond to the outer cross section of the melting wire. Preferably, the shape of the further covering corresponds to the outer cross section of the melting wire, wherein the covering can in turn correspond to the outer cross section of the further covering and/or to the outer cross section of the melting wire. In particular, the application of the further covering and/or the covering to the outer shell surface of the melting wire is carried out in such a way that there is no free space, no play and/or no pores and/or no “slip” between the melting wire and the covering and/or the further covering.

Further, the melting conductor may comprise a diameter between 1 μm to 1000 μm, more preferably between 10 μm to 600 μm, more preferably between 15 μm to 550 μm. The aforementioned thickness and/or diameter of the melting conductor is configured in particular in such a way that the switching behavior of the fuse, preferably the miniature fuse, can be ensured. Alternatively or additionally, it can be provided that the melting wire comprises a diameter between 1 μm to 800 μm, more preferably between 5 μm to 500 μm, more preferably between 10 μm to 400 μm.

In particular, the covering and/or the further covering can comprise a layer thickness between 0.01 μm to 300 μm, more preferably between 0.1 μm to 200 μm, more preferably between 1 μm to 100 μm, more preferably further between 1.5 μm to 50 μm. Particularly preferably, the covering and/or the further covering comprises an at least substantially constant layer thickness, resulting in particular in the annular and/or hollow cylindrical shape of the covering and/or the further covering.

The melting wire may comprise metal, in particular a metal alloy, as the material. The material and/or metal may be copper, silver and/or a copper alloy and/or a silver alloy. Tin and/or a tin alloy may also be provided as the material of the melting wire. Alternatively or additionally, a metal alloy and/or metal different from copper and/or silver may be provided as the material for the melting wire, in particular steel, nickel, iron and/or tungsten.

Particularly preferably, in particular to ensure the M-effect, it is provided that the material of the further covering, in particular the metal of the further covering, differs from the material of the melting conductor, in particular the metal of the melting conductor. In particular, the metal alloys of the materials differ from each other. Particularly preferably, it is provided that the melting wire is surrounded by a tin or tin alloy coating which ensures the previously described switching behavior of the melting conductor.

Furthermore, the present invention relates to a fuse, in particular a miniature fuse, having an outer fuse box, wherein at least one melting conductor wound around a winding body, in particular an electrically insulating winding body, is arranged in the fuse box according to at least one of the embodiments described above.

In the context of the fuse according to the invention, in order to avoid unnecessary repetitions and/or explanations, reference may be made to the advantages and/or special embodiments of the melting conductor which, in accordance with the invention, also apply simultaneously to the fuse. In this respect, reference is accordingly expressly made to the previous explanations, which also represent more preferably embodiments of the fuse, in particular the miniature fuse.

Particularly preferably, the fuse box is configured to be at least partially open and/or open at the two front sides. Particularly preferably, it is further provided that the fuse box comprises an at least substantially hollow-cylindrical shape, wherein in particular glass and/or ceramic can be provided as material for the fuse box. At least one contact cap designed for electrical contacting can be arranged on the front side of the fuse box, in particular for electrical contacting. The contact cap is in particular fitted and/or arranged on the front side of the fuse box in such a way that the openings of the fuse box, in which in particular the melting wire and/or the solder is arranged, are covered. An indicator can also be arranged on the front side of the fuse box. Alternatively or additionally, it may be provided that the housing comprises as material a ceramic material and/or porcelain and/or consists thereof.

Furthermore, the, preferably cylindrical, winding body may be configured as a glass fiber core and/or comprise as material at least one glass fiber and/or consist thereof. The glass fiber can in particular be configured to be electrically non-conductive and/or electrically insulating. Alternatively or additionally, it is possible in principle that glass, ceramics and/or, in particular temperature-resistant, plastics are provided as the material of the insulating fiber. Ceramic fibers may also be provided in particular for the material of the winding body.

The winding body can comprise a thickness and/or a diameter, in particular in the case of a cylindrical configuration, between 0.01 to 2 mm, preferably between 0.1 to 1 mm, more preferably between 0.2 to 0.7 mm.

The outer diameter of the winding body corresponds in particular to the number of windings of the melting conductor for a given length of the melting conductor. The thicker the winding body, the fewer turns of a melting conductor are produced for the same melting conductor length.

Advantageously, the melting conductor is wound around the winding body in such a way that the windings are close together.

The distance between directly adjacent windings of the melting conductor can be configured to be less than 0.5 mm, preferably less than 0.05 mm, more preferably less than 0.01 mm, more preferably less than 0.001 mm. Currently, in the prior art, the smallest distance between windings is a distance between 0.018 mm to 0.561 mm. According to the invention, this distance can be significantly less.

The fuse can comprise a length between 5 to 50 mm, more preferably between 6.1 to 30 mm. The length of the fuse can be selected in particular as a function of the intended use and/or country-specific requirements.

The fuse may further comprise a width between 1 to 10 mm, more preferably between 2.1 to 5.8 mm. The width can also be adapted depending on the intended use.

Further features, advantages and possible applications of the present invention will be apparent from the following description of examples of embodiments based on the drawing and the drawing itself. In this connection, all the features described and/or illustrated constitute, individually or in any combination, the subject-matter of the present invention, irrespective of their summary in the claims or their relation back.

It shows:

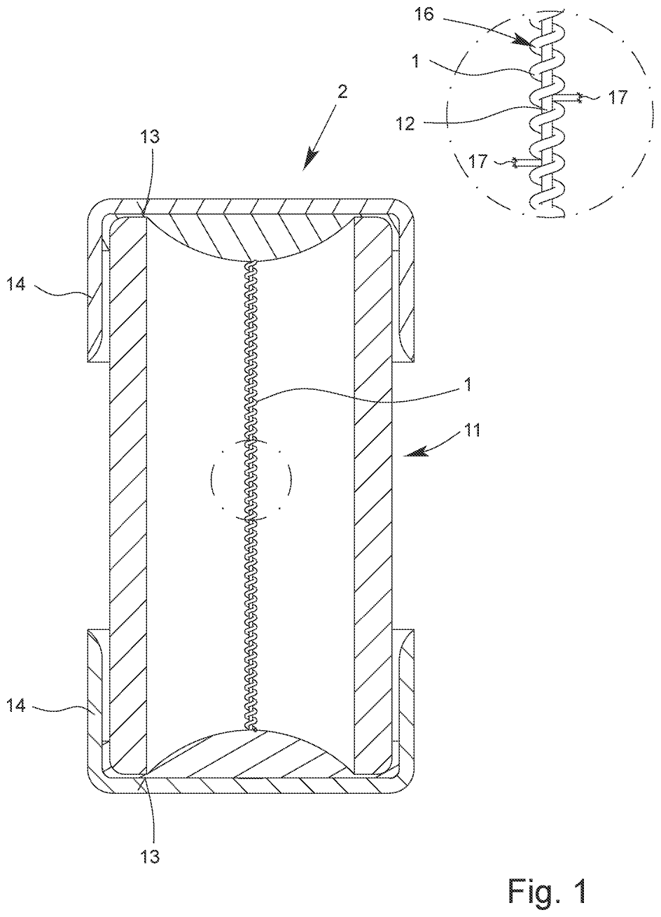

FIG. 1 a schematic cross-sectional view of a fuse according to the invention,

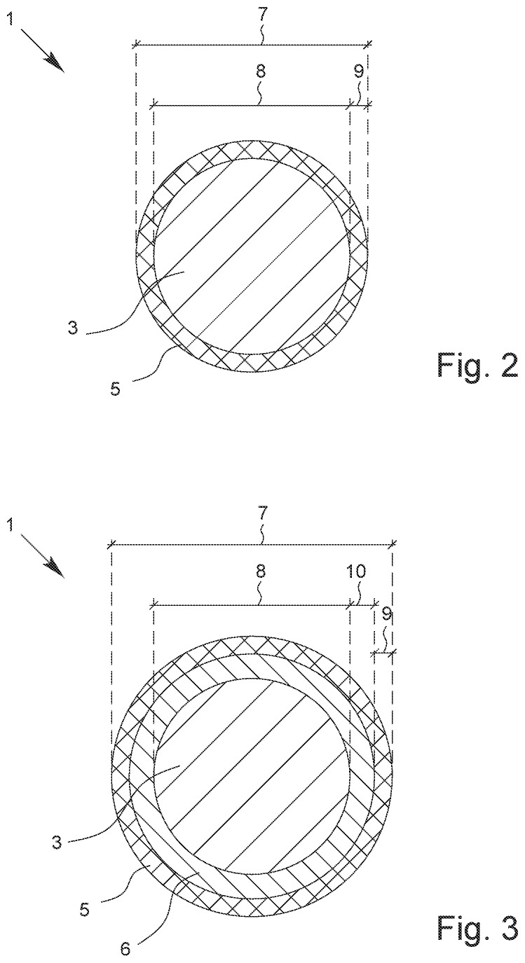

FIG. 2 a schematic cross-sectional view of a melting conductor according to the invention,

FIG. 3 a schematic cross-sectional representation of a further embodiment of a melting conductor according to the invention, and

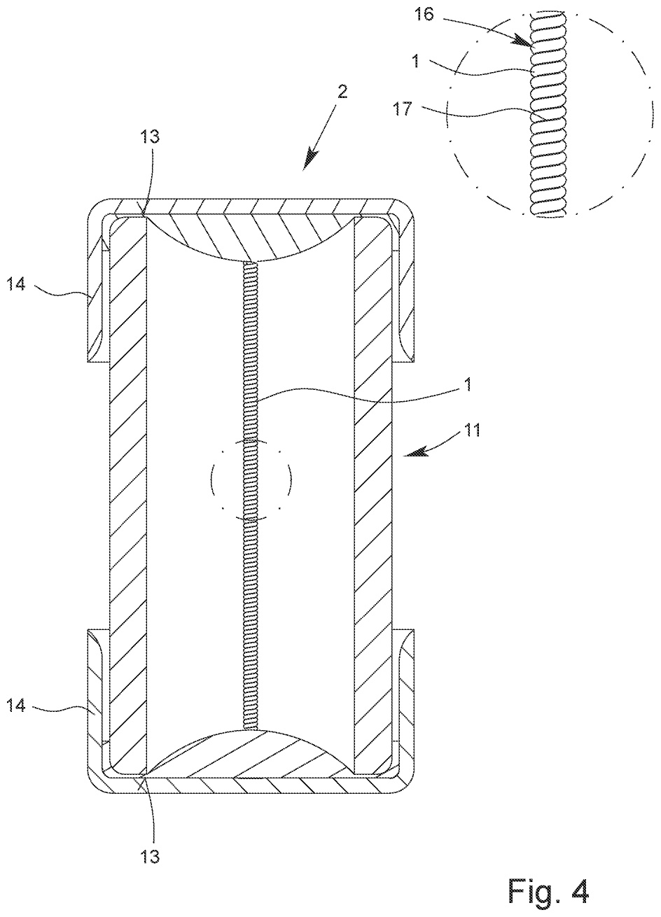

FIG. 4 a schematic cross-sectional view of a further embodiment of a fuse according to the invention.

FIG. 2 shows a melting conductor 1 intended for use for a fuse 2, as shown in FIG. 1 and FIG. 4.

In the embodiment example shown here, a miniature fuse 2 is provided as the fuse 2.

The melting conductor 1 comprises an electrically conductive melting wire 3. The melting wire 3 may comprise an at least substantially circular cross-section, as shown in FIGS. 2 and 3.

FIG. 2 shows that at least in certain areas, in particular completely, the outer shell surface 4 of the melting wire 3 is surrounded by an electrically insulating and/or electrically non-conductive covering 5. In the embodiment shown in FIG. 2, it is provided that the covering 5 is directly adjacent to the outer shell surface 4 of the melting wire 3. In particular, no play and no slip or at least substantially no (clear) distance is provided between the outer shell surface 4 and the covering 5.

FIG. 3 shows that the covering 5 indirectly surrounds the outer shell surface 4 of the melting wire 3, wherein a further layer and/or covering 6 is provided between the outer shell surface 4 of the melting wire 3 and the inner side of the covering 5 facing the melting wire 3.

The covering 5 may be configured as a coating and/or a lacquer. The coating may be formed by a solution of polymers in a, in particular cresolic, solvent mixture. Alternatively or additionally, the coating may comprise resin as the material, preferably dissolved in a solvent mixture. Additives and/or a curing catalyst may be added to the resin dissolved in the solvent mixture.

Furthermore, the covering 5 and/or the coating may comprise a plastic, preferably polyurethane, as material and/or be configured as a polyimide coating.

In the embodiment of the melting conductor 1 shown in FIG. 2, it is provided that the covering 5 is configured as a lacquer, wherein during production of the melting conductor 1 the melting wire 3 has been coated several times, in particular between 6 to 20 times, with the lacquer to configure the covering 5, wherein the lacquer has subsequently been baked at temperatures between 300 to 600° C.

Furthermore, the covering 5 shown in FIG. 2 is configured to be metal-free.

It is not shown that the covering 5 is configured as a silicone covering. In this respect, the covering 5 may comprise silicone and/or consist thereof.

As mentioned before, the covering 5 may comprise and/or consist of a material made of plastic, irrespective of its design as a paint layer. Particularly preferably, the material is configured in such a way that the covering 5 is electrically insulating and/or electrically non-conductive.

Furthermore, in the embodiment example shown in FIG. 2, it is provided that the material of the covering 5 comprises a proportion and/or a mass proportion of the total material of the melting conductor 1 between 5 to 15 wt. %. In further embodiments not shown in detail, the mass fraction of the material of the covering 5 in the total material and/or total mass fraction of the melting conductor 1 may vary between 0.1 to 25 wt. %.

FIG. 3 shows that the melting conductor 1 comprises a further covering 6 surrounding the melting wire 3, in particular directly, at least in certain areas. The further covering 6 is arranged between the melting wire 3 and the covering 5. Furthermore, the further covering 6 comprises as material a metal, in particular a metal alloy in the illustrated embodiment tin and/or a tin alloy. Thereby, the material, in particular the metal, of the melting wire 3 may differ from the metal of the further covering 6. The materials of the melting wire 3 and the further covering 6 are matched to each other in such a way that the M-effect described above can be ensured in the event of tripping.

FIG. 3 further shows that the melting wire 3 comprises a circular outer cross-section, wherein both the covering 5 and the further covering 6 also comprise an at least substantially circular outer cross-section. Thereby, the melting wire 3 may comprise a cylindrical shape. The further covering 6 and the covering 5 may comprise an annular cross-section and in particular form a hollow cylindrical shape.

Furthermore, FIG. 3 shows that no free space between the layers:
Melting wire 3, further covering 6 and covering 5.
   is provided. The aforementioned layers or the aforementioned components 3, 5, 6 are directly adjacent to each other.

The melting conductor 1 shown in FIG. 2 comprises a diameter 7 between 15 μm to 550 μm. The melting conductor 3, in turn, may comprise a diameter 8 between 10 μm to 400 μm. The covering 5 shown in FIG. 2 can in particular comprise a diameter between 1.5 μm to 50 μm.

The melting conductor 3 may comprise metal, in particular a metal alloy, as the material. The metal and/or material of the melting wire 3 may be copper, silver and/or tin and/or a copper alloy, a silver alloy and/or a tin alloy.

As mentioned before, the material of the further covering 6 is configured differently from the material of the melting wire 3 in the embodiment example shown in FIG. 3, wherein in particular the metal alloys of the materials differ from each other.

FIG. 1 shows a fuse 2, in the embodiment shown a miniature fuse 2. The fuse 2 comprises a fuse box 11, wherein at least one melting conductor 1 wound around an electrically insulating winding body 12 is provided in the fuse box 11 according to one of the embodiments described above.

The fuse box 11 may be configured to be hollow, in particular hollow-cylindrical, and may comprise as material glass and/or ceramic (in further embodiments).

In FIG. 4, a further embodiment of the fuse 2 is shown. FIGS. 1 and 4 differ in that the distance 17 between directly adjacent windings 16 of the melting conductor 1 is configured differently. Due to the electrically insulating covering 5, the windings 16 can be wound close together so that the distance 17 can be reduced to almost zero. However, spacing of the windings 16 can also be provided, as can be seen in detail in FIG. 1. Both embodiments can be implemented with the melting conductor 1.

Not shown is that the fuse box 11 is configured to be at least partially open at the two front sides 13. The melting conductor 1 can be guided through the opening.

FIGS. 1 and 4 show that at least one contact cap 14, in particular a metallic contact cap, is arranged on the front side (on the front sides 13) of the fuse box 11 for making electrical contact. The contact cap 14 can close the openings of the fuse box 11, which can be provided on the front side.

The winding body 12 shown in FIGS. 1 and 4 may comprise a cylindrical shape and/or be configured as a glass fiber core. In this case, the winding body 12 may comprise at least one glass fiber as a material and/or be made thereof.

The winding body 12 shown in FIG. 1 comprises a thickness or diameter between 0.2 to 0.7 mm.

FIG. 4 shows, in particular in comparison with FIG. 1, that the distance 17 between directly adjacent windings 16 of the melting conductor 1 wound around the winding body 12 can be configured to be very small. In the illustrated embodiment example, the distance 17 is less than 0.05 mm, in particular less than 0.01 mm.

In the winding of the melting conductor 1 shown in FIG. 1, it is envisaged that the distances 17 known from the prior art are provided, which range from 0.018 to 0.561 mm.

The fuse 2 may comprise a length between 6.1 to 30 mm and/or greater than 30 mm, in particular between 30 mm to 60 mm. The width of the fuse 2 may further be between 2.1 to 5.8 mm and/or between 5.8 to 15 mm and/or greater than 5.8 mm.

FIG. 4 shows in detail that the distance 17 between directly proximate windings 16 can be reduced to almost zero or to a very small distance 17. Accordingly, the windings 16 can be directly adjacent to each other, so that the coverings 5 of directly adjacent windings 16 of the melting conductor 1 can contact each other, in particular abut each other over their entire surface.

### LIST OF REFERENCE SIGNS

1 Melting conductor
2 Fuse
3 Melting wire
4 Outer shell surface of 3
5 Covering
6 Further covering
7 Diameter of 1
8 Diameter of 3
9 Layer thickness of 5
10 Layer thickness of 6
11 Fuse box
12 Winding body
13 Front side
14 Contact cap
15 Thickness of 12
16 Winding
17 Distance

1. A melting conductor provided for use for a fuse, preferably for a miniature fuse, with an electrically conductive melting wire, wherein
an electrically insulating and/or electrically non-conductive covering is provided which surrounds the outer shell surface of the melting wire at least in regions, preferably completely.

2. The melting conductor according to claim 1, wherein the covering is configured as a coating, preferably as a lacquer, in particular wherein the coating is formed by a solution of polymers in a, in particular cresolic, solvent mixture and/or wherein the coating comprises as material resin, preferably dissolved in a solvent mixture, preferably with the addition of additives and/or a curing catalyst, and/or wherein the coating comprises as material a plastic, preferably polyurethane, and/or is configured as a polyimide lacquer.

3. The melting conductor according to claim 1, wherein the covering is designed metal-free and/or in that the covering is configured as a silicone covering and/or comprises as material a plastic and/or silicone and/or consists thereof.

4. The melting conductor according to claim 1, wherein the material of the covering comprises a proportion of the total material of the melting conductor between 0.1 and 25 wt. %, preferably between 1 and 20 wt. %, more preferably between 5 and 15 wt. %.

5. The melting conductor according to claim 1, wherein the melting wire comprises a further covering surrounding the melting wire at least in regions, wherein the further covering is arranged between the melting wire and the covering, in particular wherein the further covering comprises as material metal, in particular a metal alloy, preferably tin and/or a tin alloy.

6. The melting conductor according to claim 1, wherein the melting wire, the covering and/or the further covering comprise an at least substantially circular outer cross section.

7. The melting conductor according to claim 1, wherein the melting conductor comprises a diameter between 1 μm to 1000 μm, preferably between 10 μm to 600 μm, more preferably between 15 μm to 550 μm, and/or in that the melting wire comprises a diameter (8) between 1 μm to 800 μm, preferably between 5 μm to 500 μm, more preferably between 10 μm to 400 μm, and/or in that the covering and/or the further covering comprises a layer thickness between 0.01 μm to 300 μm, preferably between 0.1 μm to 200 μm, more preferably between 1 μm to 150 μm, more preferably further between 1.5 μm to 50 μm.

8. The melting conductor according to claim 1, wherein the melting wire comprises as material metal, in particular a metal alloy, in particular wherein the material comprises copper, silver and/or a copper alloy and/or a silver alloy.

9. The melting conductor according to claim 1, wherein the material of the further covering differs from the material of the melting wire, in particular wherein the metal alloys of the materials differ from each other.

10. A fuse, in particular a miniature fuse, having an outer fuse box, wherein at least one melting conductor wound around a winding body, in particular an electrically insulating winding body, is arranged in the fuse box.

11. The fuse according to claim 10, wherein the fuse box is configured to be at least partially open on two front sides, wherein at least one contact cap configured for electrical contacting is arranged on each front side of the fuse box.

12. The fuse according to claim 10, wherein the, preferably cylindrical, winding body is configured as a glass fiber core and/or comprises as material at least one glass fiber and/or consists thereof, in particular wherein the winding body comprises a thickness and/or a diameter between 0.01 and 2 mm, preferably between 0.1 and 1 mm, more preferably between 0.2 and 0.7 mm.

13. The fuse according to claim 10, wherein the distance between directly adjacent windings of the melting conductor wound around the winding body is configured to be less than 0.5 mm, preferably less than 0.05 mm, more preferably less than 0.01 mm, more preferably further less than 0.001 mm.
